(19) United States
(12) Patent Application Publication
(10) Pub. No.: US 2007/0225061 A1
(43) Pub. Date: Sep. 27, 2007

(54) SLOT MACHINE CAPABLE OF CHANGING GAME RULES

(75) Inventor: Hiroshi Naobayashi, Zama city (JP)

Correspondence Address: GLOBAL IP COUNSELORS, LLP, 1233 20TH STREET, NW, SUITE 700, WASHINGTON, DC, 20036-2680, US

(73) Assignee: KONAMI GAMING INCORPORATED, Las Vegas, NV (US)

(21) Appl. No.: 11/690,854

(22) Filed: Mar. 26, 2007

(30) Foreign Application Priority Data
Mar. 27, 2006 (JP) 2006-086310

(51) Int. Cl. A63F 13/00

(52) U.S. Cl. 463/20

(57) ABSTRACT

A slot machine of the present invention selectively provides a game in normal and special modes. A winning judgment unit assigns winning combinations of symbols to various awards depending on the modes. During the normal mode, the awards comprise awards which change from the normal mode to the special mode, and awards which change the rules (the maximum number of rounds and the payouts) used in the special mode. The winning judgment unit checks whether or not a winning combination is included in a symbol arrangement determined randomly. A memory unit stores rule data used in the special mode. A rule managing unit updates the rule data stored in the memory unit in accordance with an award won in the normal mode. A controller unit conducts a game in each mode, changes the modes according to the award won in the normal mode, and uses the rule data in the special mode.

### BACKGROUND OF THE INVENTION

1. Field of the Invention

The present invention relates to a slot machine that is installed in a casino or the like.

2. Background Information

Slot machines that allow a player to play a game selectively in normal and special modes are known (cf. Japan Published Patent Application No. 2003-52905). The slot machine provides a normal slot game and a big bonus (BB) game in the normal and special modes, respectively. When a BB award is won in the normal mode, the slot machine changes from the normal mode to the special mode, and starts the BB game. A round of the BB game is continued until a player plays 30 rounds of a small bonus (SB) game in which the winning probability of a player is set to be higher than in the normal game, or 3 rounds of a regular bonus (RB) game. When a round of the BB game is finished, the slot machine changes from the special mode to the normal mode. A player can play a round of the RB game each time he/she wins an RB award in the SB game. A round of the RB game is continued until the player wins any RB-game-specific award 8 times or spins the reels 12 times.

In general, players aim to only play the BB game on the slot machine, since the BB game provides the players with a chance to win a larger number of coins. The normal slot game is of value for such players simply in order to win the right to play the BB game, and accordingly cannot attract players. In order to make the normal slot game more attractive, the slot machine provides a number of points to a player who plays a normal slot game as follows. Each time a specific symbol is stopped at a predetermined position, the slot machine selects one of a plurality of events at random, and increments a number of points on the basis of the selected event and the stopped position of the specific symbol. When the BB award is won in the normal slot game, the maximum number of times the RB award can be won per round of the BB game is increased depending on the total number of the points. The larger the number of points recorded, a larger maximum number of times the RB award can be won will be assigned. For example, the player who has accumulated a large number of points can win the RB award 4 or more times per round of the BB game. In contrast to this, a player who has no points can win the RB award only 3 times per round of the BB game. This helps make the normal slot game attractive. However, the slot machine increments the points monotonously during the normal mode, and increases the maximum number of times the RB award can be won per round of the BB game monotonously. This adds a little value to the normal slot game for the players' advantage in order to play the BB game. Accordingly, the slot machine makes the normal slot game attractive at an only limited level.

In view of the above, it will be apparent to those skilled in the art from this disclosure that there exists a need for an improved slot machine that selectively provides a game in normal and special modes, and makes the normal mode more attractive than similar types of conventional slot machines. This invention addresses this need in the art as well as other needs, which will become apparent to those skilled in the art from this disclosure.

### SUMMARY OF THE INVENTION

A slot machine according to the present invention selectively provides a game in a normal mode and a special mode. The slot machine preferably conducts a normal slot game and a bonus game (e.g., an event, a free game, and a feature game) in the normal mode and the special mode, respectively.

The slot machine comprises a reel unit, a console unit, a bet processing unit, a start signal generator unit, a lottery unit, a reel control unit, a winning judgment unit, a payout processing unit, a memory unit, a rule managing unit, and a controller unit.

The reel unit is configured to display a plurality of reels. Each of the reels comprises a series of symbols arranged in a predetermined order. The reel unit preferably comprises an electronic display, and the reels are preferably video reels, i.e., reel images virtually reproduced on a screen of the electronic display. Alternatively, the reels may be mechanical and revolved by means of a stepping motor. In this case, the reel unit may comprise a motor driver.

The console unit is configured to allow a player to enter bet data therein. The console unit preferably comprises mechanical buttons, or alternatively may comprise a touch panel on which virtual buttons are displayed.

The bet processing unit is configured to receive an amount of credits equal to the amount of a bet represented by the bet data when the console unit has accepted the bet data.

The start signal generator unit is configured to generate a start signal after the bet processing unit has received an amount of credits. The start signal generator unit preferably generates a start signal at the time when a player pushes a spin button or pulls a lever. The spin button and the lever are preferably included in the console unit.

The lottery unit is configured to determine each symbol to be arranged on the reels in stopped positions by the reel unit in response to the start signal. The lottery unit preferably generates and uses a random number in random determination of the symbols.

The reel control unit is configured to cause the reel unit to start continuously changing the symbols by means of the rotation of the reels in response to the start signal, and after that, arrange the symbols that the lottery unit has determined on the reels in the stopped positions. When the reels are mechanical, the reel control unit may control the stepping motors, and thereby may control the rotation of the reels.

The winning judgment unit is configured to assign winning combinations of symbols to various types of awards, which comprise an award in which a payout is received, depending on the modes of a game. While the game is conducted in the normal mode, the awards comprise an award in which the game is changed from the normal mode to the special mode and the rules to be used in the special mode are changed. The winning judgment unit is further configured to check whether or not one of the winning combinations is included in the arrangement of the symbols that the lottery unit has determined.

The payout processing unit is configured to provide a payout on the basis of the bet data and the winning combination that the winning judgment unit has found in the arrangement of the symbols.

The memory unit is configured to store rule data used in the special mode. The rule data preferably indicates the duration of the special mode, e.g., the maximum number of rounds of a game conducted in the special mode. Alternatively, the rule data may indicate the types of awards (preferably, the amounts of payouts) assigned to winning combinations by the winning judgment unit in the special mode.

The rule managing unit is configured to update the rule data stored in the memory unit in accordance with the winning combination that the winning judgment unit has found in the arrangement of the symbols.

The controller unit is configured to conduct a game selectively in the normal and special modes. The controller unit is further configured to change from the normal mode to the special mode in accordance with the winning combination that the winning judgment unit has found in the arrangement of the symbols, and use the rule data stored in the memory unit in the special mode.

The slot machine according to the present invention provides a player with a chance to change the rules (e.g., the maximum number of rounds and the payout amounts) to be used in the special mode, while the game is conducted in the normal mode. This may make the normal mode more attractive, since there is a chance to change the rules used in the special mode (in particular, to a player's advantage) depending on the game result in the normal mode. Thus, the slot machine may induce a larger number of players to play games thereon.

The slot machine according to the present invention preferably comprises a rule check unit. The rule check unit is configured to check whether or not a predetermined condition is satisfied between the original rule data stored in the memory unit and new rule data updated in accordance with the winning combination that the winning judgment unit has found in the arrangement of the symbols. In this case, the rule managing unit is preferably configured to replace the original rule data with the new rule data, when the rule check unit has judged that the predetermined condition is satisfied. The predetermined condition is preferably a condition in which the new rule data is different from the original rule data. The predetermined condition is more preferably a condition in which the new rule data is advantageous to a player over the original rule data. If a player who plays a game in the normal mode wins the award which allows the rules to be used in the special mode to be changed, the player will always play a game in the special mode under more advantageous rules. This may makes the normal mode even more attractive, since there is little doubt that winning an award that changes the rules always enhances the player's willingness to play a game on the slot machine.

In contrast, the rule managing unit may be configured to update the rule data stored in the memory unit, whenever the winning judgment unit has found the winning combination assigned to the award that changes the rules to be used in the special mode. In this case, the rule data will be updated regardless of the relationship between the original and updated rule data, and accordingly the rule check unit may be eliminated. This reduces the burdens of updating the rule data on the slot machine.

The slot machine according to the present invention preferably comprises a rule selecting unit that is configured to select one of the rule data stored in the memory unit by using a lottery process. In this case, the rule managing unit is preferably configured to add new rule data to the rule data stored in the memory unit in accordance with the winning combination that the winning judgment unit has found in the arrangement of the symbols. In addition, the controller unit is preferably configured to use the rule data selected by the rule selecting unit in the special mode. During the normal mode, each time the award which changes the rules used in the special mode is won will increase the variety of the rules selectable by the rule selecting unit. This may makes the normal mode even more attractive, since a player who wins the award that changes the rules a larger number of times in the normal mode, has greater chances of playing a game in the special mode under more advantageous rules.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a portion of this original disclosure:

FIG. 1 is a flow chart of a round of a slot game conducted in a normal mode of a slot machine according to an embodiment of the present invention;

FIG. 2 is a perspective view of the appearance of the slot machine according to the embodiment of the present invention;

FIG. 3 is a block diagram of the hardware configuration of a main controller unit included in the slot machine shown in FIG. 2;

FIG. 4 is a block diagram of the hardware configuration of a sub-controller unit included in the slot machine shown in FIG. 2;

FIG. 5A shows an example of a symbol arrangement of stopped video reels displayed on a game screen in the normal mode;

FIG. 5B shows an example of a symbol arrangement of stopped video reels displayed on a game screen in the special mode;

FIG. 6 is a flow chart of a round of a slot game conducted in a normal mode of a slot machine according to a modification of the embodiment shown in FIG. 1;

FIG. 7 is a flow chart of a round of a slot game conducted in a normal mode of a slot machine according to another modification of the embodiment shown in FIG. 1; and

FIG. 8 is a flow chart of a round of a slot game conducted in a normal mode of a slot machine according to yet another modification of the embodiment shown in FIG. 1.

### DETAILED DESCRIPTION OF THE PREFERRED EMBODIMENT

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

A preferred embodiment of the present invention is a video slot machine preferably installed in a casino. The slot machine selectively provides a game in a normal mode and a special mode. The slot machine preferably conducts a normal slot game and a bonus game (e.g., an event, a free game, and a feature game) in the normal mode and the special mode, respectively.

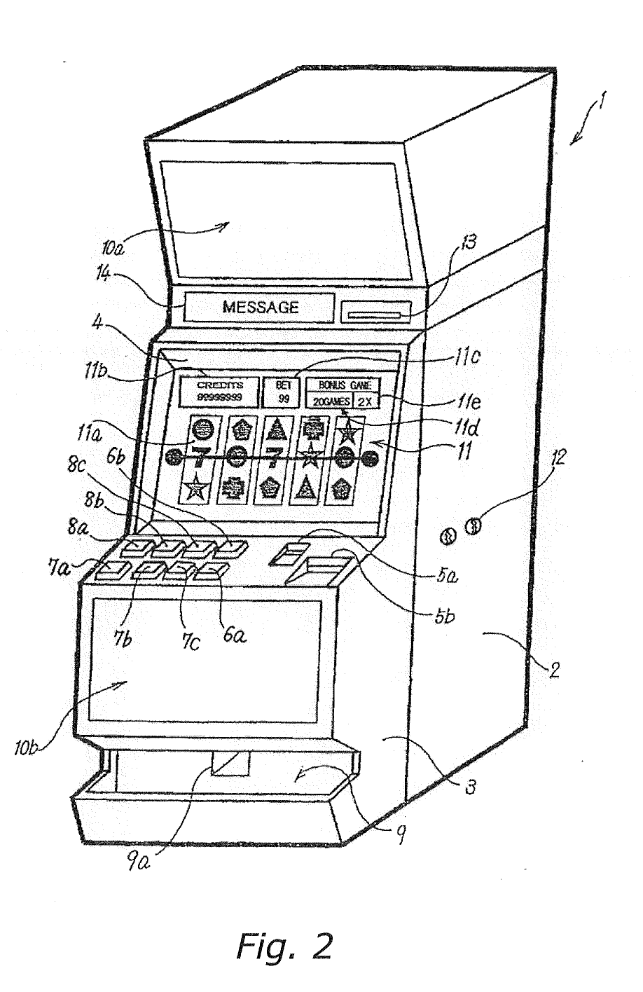

At first, the basic configuration of the slot machine will be described below. As shown in FIG. 2, the slot machine 1 comprises a box-shaped cabinet 2, and a front panel 3 that is coupled to the front of the cabinet 2 so that the cabinet can be opened and closed. On the front panel 3 are provided, for example, a display window 4, a coin slot 5a, a bill slot 5b, a spin button 6a, a cash out button 6b, bet buttons 7a, 7b, 7c, payline selection buttons 8a, 8b, 8c, a coin tray 9, and various types of lamps 10a and 10b. A monitor 11 is visible through the display window 4. Coins are discharged from a coin chute 9a, and then stored in the coin tray 9. The buttons 6a, 6b, 7a, 7b, 7c, 8a, 8b, and 8c are preferably mechanical lamp buttons including light emitting devices which emit light when pushed. Alternatively, the buttons may be virtual button images displayed on a touch panel mounted on the monitor 11.

The monitor 11 is placed inside the slot machine 1. The monitor 11 displays a column of various symbols arranged in a predetermined order, i.e., a video reel, on each of five symbol display areas 11a, which constitute a reel unit. The monitor 11 is preferably included in a liquid crystal display, or alternatively, may be included in a cathode-ray-tube display or a plasma display. The monitor 11 also displays a credit display area 11b, a bet display area 11c, a bonus round display area 11d, and an odds display area 11e above the five symbol display areas 11a. The total amount of money that a player has inserted into the coin slot 5a and the bill slot 5b is assigned to an amount of credits in credit data, and is displayed on the credit display area 11b. The amount of bets that the player has placed by using the buttons 7a, 7b, 7c, 8a, 8b, and 8c is displayed on the bet display area 11c. The number of rounds of a bonus game conducted in the special mode is displayed on the round display area 11d. The payout ratio of the special mode to the normal mode is displayed on the odds display area 11e.

A coin counter, a coin acceptor, a coin payout device, and a speaker are installed inside the slot machine 1 (not shown in FIG. 2). The coin counter counts the amount of coins and bills inserted into the coin slot 5a and the bill slot 5b, respectively. The coin acceptor validates the coins and bills. The coin payout device includes a hopper, and can hold a large number of coins.

A reset switch 12 is provided on one side of the slot machine 1. The reset switch 12 preferably includes a keyhole, and is activated by the insertion of a specific key into the keyhole. The specific keys are preferably possessed by casino attendants. Accordingly, players cannot operate the reset switch 12.

A card slot 13 and a sub-display unit 14 are mounted on an upper portion of the slot machine 1. A house card can be inserted into the card slot 13. The house card is a removable recording medium usable within the casino, and provided to each player who has, for example, registered at a reception desk of the casino. The house card stores data for identification of an individual player, i.e., a player ID. On the other hand, a management server installed in the casino stores personal information of each registered player and is linked to the player ID thereof. The management server also stores the amount of credits for each player and is linked to the player ID thereof. The amount of credits is equivalent to the amount of money that the player has entrusted to the casino in advance. The house card is used by the management server in keeping track of the number of points that represents the amount of credits that the player has spent on games. The player can be provided with bonuses such as free accommodation coupons, depending on the total number of the points. The sub-display unit 14 displays the number of the points provided to the player. The house card is further used in order to allow the money that has been entrusted to the casino in advance to be used as credits in playing games on the slot machine 1 (details will be described below).

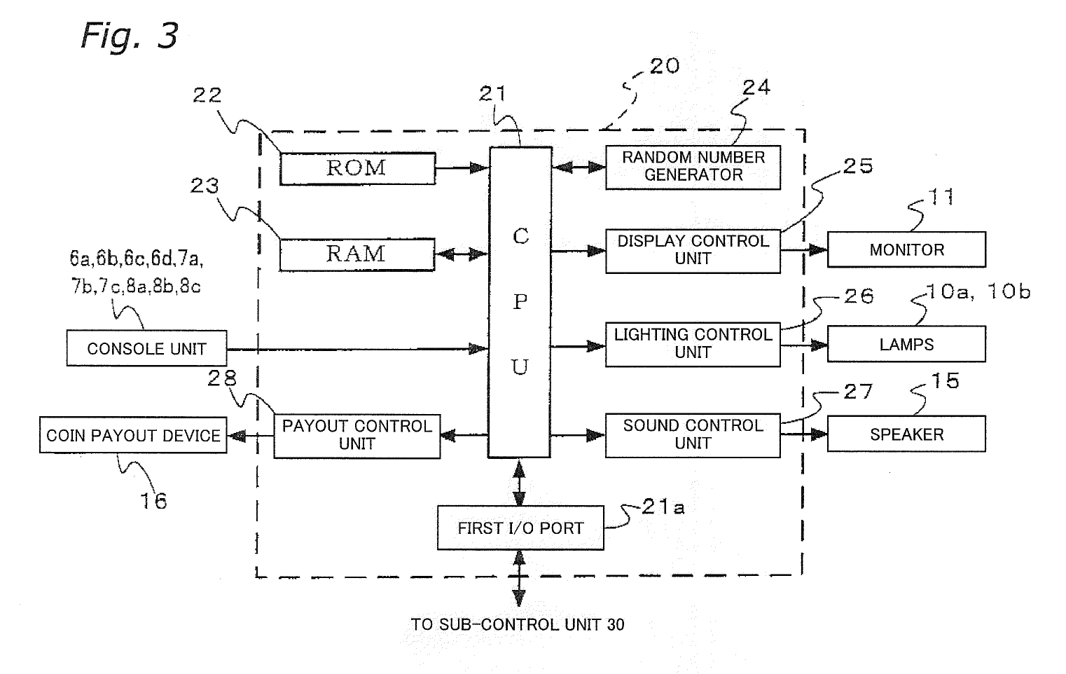

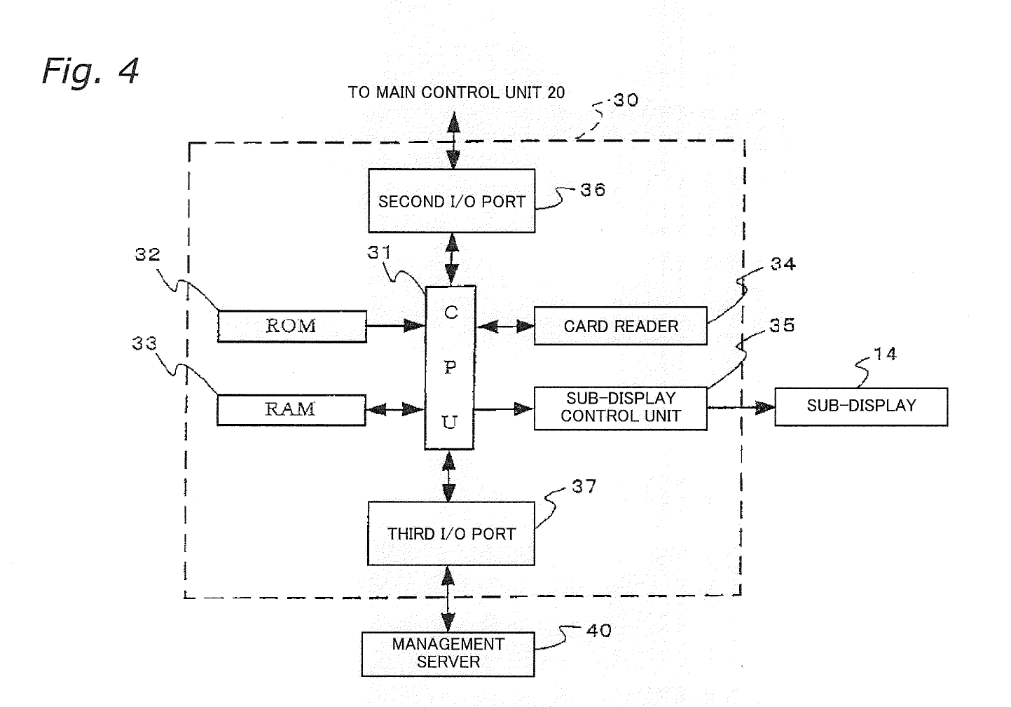

The slot machine 1 comprises a main controller unit 20 and a sub-controller unit 30 (cf. FIGS. 3 and 4, respectively).

As shown in FIG. 3, the main controller unit 20 includes a first CPU 21, a first I/O port 21a, a first ROM 22, a first RAM 23, a random number generator 24, a display control unit 25, a lighting control unit 26, a sound control unit 27, and a payout control unit 28. The first I/O port 21a is used in data communication between the main controller unit 20 and the sub-controller unit 30. The first ROM 22 stores various programs and databases for use by the first CPU 21. The first RAM 23 temporally stores parameters computed by the first CPU 21. The random number generator 24 generates and provides random numbers to the first CPU 21 at regular intervals. The display control unit 25 controls the display on the monitor 11 under the control of the first CPU 21. The display control unit 25 in particular controls the display of video reels on the symbol display areas 11a, and thereby serves as a reel control unit. The lighting control unit 26 switches the lamps 10a and 10b on and off under the control of the first CPU 21. The sound control unit 27 controls the speaker 15 in order to reproduce voice announcements, sound effects, and the like, under the control of the first CPU 21. The payout control unit 28 controls the coin payout device 16, thereby supplying a proper amount of coins through the coin chute 9a to the coin tray 9 under the control of the first CPU 21.

The spin button 6a, the cash out button 6b, the bet buttons 7a, 7b, 7c, and the payline selection buttons 8a, 8b, and 8c constitutes a console unit, which is connected to the first CPU 21. Moreover, the coin counter and the coin acceptor is also connected to the first CPU 21 (not shown in figures).

As shown in FIG. 4, the sub-controller unit 30 includes a second CPU 31, a second ROM 32, a second RAM 33, a card reader 34, a sub-display control unit 35, a second I/O port 36, and a third I/O port 37. The second ROM 32 stores various programs and databases for use by the second CPU 31. The second RAM 33 temporally stores parameters computed by the second CPU 31. The card reader 34 reads a player ID from the house card inserted into the card slot 13, and provides the player ID to the second CPU 31. The sub-display control unit 35 controls the sub-display unit 14 under the control of the second CPU 31. The second I/O port 36 is used in data communication between the main controller unit 20 and the sub-controller unit 30. The third I/O port 37 is used in data communication between the sub-control circuit board 30 and the management server 40 of the casino. Here, the management server 40 collectively controls a plurality of slot machines in the casino, including the slot machine 1.

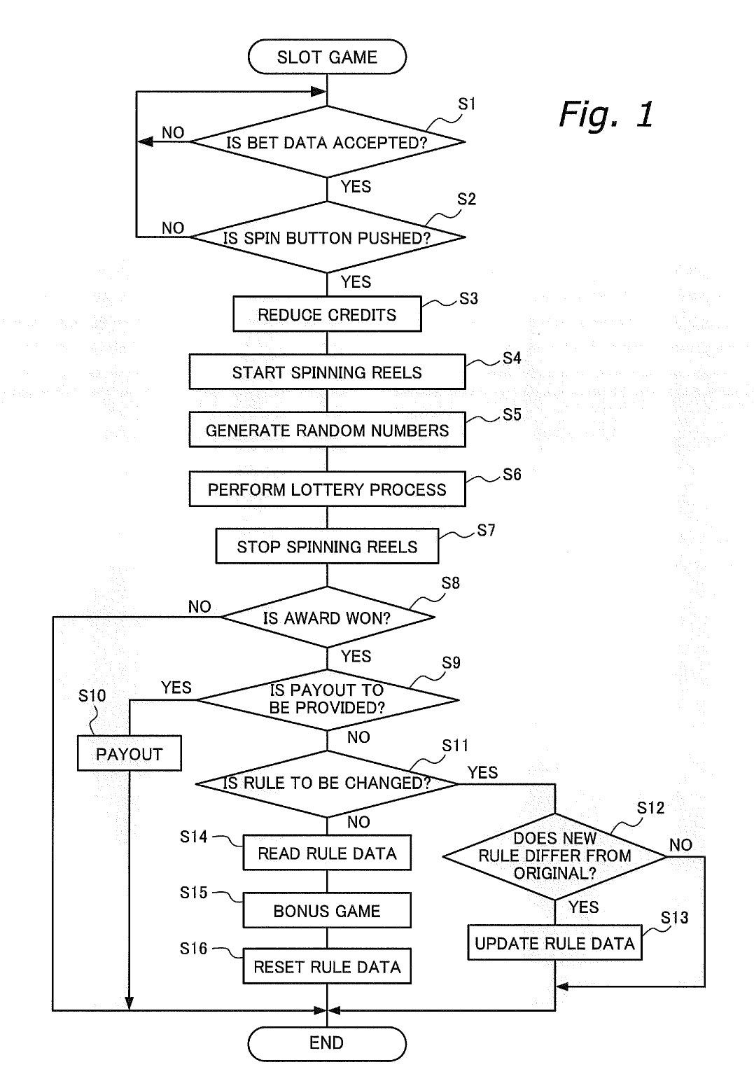

On the slot machine 1, a player can play a slot game. The operation of each unit of the slot machine 1 will be explained in the order of the flow of a slot game on the slot machine 1 (cf. FIG. 1).

A player inserts coins or bills into the coin slot 5a or the bill slot 5b, respectively. Then, the coin acceptor validates the coins and bills, and the coin counter counts the valid coins and bills. The first CPU 21 of the main controller unit 20 reads the count of the coin counter, and updates credit data stored in the first RAM 23 to increase credits by the number corresponding to the count.

Alternatively, the player can add an amount of credits stored in the management server 40 to the amount of credits in the credit data in the following steps. First, the player inserts a house card in which his/her own player ID is stored into the card slot 13. Then, the card reader 34 of the sub-control unit 30 reads the recorded player ID from the inserted house card, and sends the read player ID to the second CPU 31 of the sub-control unit 30. The second CPU 31 receives the player ID from the card reader 34, and determines whether the player ID is valid or not. Note that the management server 40 may perform the determination instead of the controller unit of the slot machine 1. In this case, the second CPU 31 sends the received player ID to the management server 40, and then receives the results of the determination from the management server 40 as a response to the player ID.

When the player ID is determined to be invalid, the second CPU 31 sends a signal representing the invalidity to the first CPU 21 of the main control unit 20. The first CPU 21 receives the signal, and then commands the display control unit 25 to display an error message on the monitor 11. On the other hand, the second CPU 31 commands the card reader 34 to discharge the house card from the card slot 13 by using a card discharge signal.

When the player ID is determined to be valid, the second CPU 31 sends a request for credit data linked to the player ID received from the card reader 34 to the management server 40 through the third I/O port 37. In response to the request, the management server 40 retrieves the credit data linked to the player ID from a database, and then sends the credit data to the slot machine 1. The third I/O port 37 of the sub-control unit 30 receives the credit data, and then the second CPU 31 transfers the credit data from the third I/O port 37 to the first CPU 21 of the main control unit 20. The first CPU 21 uses the received credit data to update the credit data stored in the first RAM 23. Thus, the player can use an amount of credits stored in the management server 40 in order to play games on the slot machine 1. In this case, players do not have to carry cash within the casino. This facilitates playing games in the casino.

As shown in the flow chart of FIG. 1, the player can place a desired bet on a desired payline by using the console unit, in particular, the bet buttons 7a, 7b, 7c, and the payline selection buttons 8a, 8b, 8c (Step S1). The slot machine 1 comprises three paylines, and allows the player to selectively place 0-3 units of credits on each payline as a bet, for example. More specifically, the player selectively pushes the payline selection buttons 8a, 8b, 8c corresponding to the desired paylines. Next, the player selectively pushes the bet buttons 7a, 7b, and 7c corresponding to the desired bet, 1, 2, and 3 units of credits, respectively. The console unit accepts the bet placement operation, and sends data representing the contents of the operation (hereinafter, bet data) to the first CPU 21 of the main controller unit 20. Then, the first CPU 21 changes its status to enable an operation signal from the spin button 6a, and thereby the player can spin the video reels by using the spin button 6a.

The player pushes the spin button 6a (Step S2), and then the first CPU 21 functions as a bet processing unit, i.e., it updates the credit data stored in the first RAM 23 to decrease the amount of the credits by the total amount of the bets represented by the bet data (Step S3). For example, the player places the same amount (e.g., 2 units) of credits on each of the selected paylines (e.g., 3 paylines), and then the total amount of the bets is equal to the product of the number of the selected paylines and the amount of the credits per payline (e.g. 6 units of credits).

After that, the first CPU 21 functions as a start signal generator unit, i.e., it generates and sends a start signal to the display control unit 25. In response to the start signal, the display control unit 25 starts the display of spinning video reels, i.e., a continuous change of symbols displayed on the five symbol display areas 11a of the monitor 11 (Step S4).

The first CPU 21 and the random number generator 24 functions as a lottery unit as follows. The first CPU 21 sends the start signal to the random number generator 24. In response to the start signal, the random number generator 24 generates five random numbers, and provides them in turn to the first CPU 21 (Step S5). Each of the five random numbers is assigned to a video reel displayed on one of the five symbol display areas 11a. The first CPU 21 accesses the first ROM 22, and compares the five random numbers with items of different tables (hereinafter, stop position tables). Each of the stop position tables is assigned to a video reel displayed on one of the five symbol display areas 11a, and represents a predetermined link between random numbers and symbols included in each video reel. The first CPU 21 then determines the stop positions of the video reels that represent the symbols linked to the random numbers in the stop position tables. The symbols will be displayed on the five symbol display areas 11a as stopped video reels after the display of spinning video reels.

The first CPU 21 and the random number generator 24 also functions as a winning judgment unit, i.e., they determine whether or not to provide an award to the player under a lottery process as follows. The first CPU 21 accesses the first ROM 22, and compares the combination of the five random numbers with the items of a table (hereinafter, a winning combination table) that represents a predetermined link between combinations of five random numbers and awards (Step S6). Here, each of the random numbers is linked to a symbol in one of the stop position tables. Accordingly, the awards are assigned to specific arrangements (i.e., winning combinations) of symbols on the stopped video reels displayed on the five symbol display areas 11a. Preferably, winning combinations are assigned to arrangements where symbols of the same type (and a wildcard symbol) are stopped in three or more consecutive symbol display areas. The types of awards depend on which types of symbols are repeatedly included in the corresponding winning combinations. The types of the awards further vary with the modes of the slot machine 1. In the normal mode, the awards are broadly divided into three types: receiving a predetermined amount of a payout; changing from the normal mode to the special mode in order to play a bonus game, i.e., a special game such as an event, a free game, a feature game, or the like; and changing rules to be used in the special mode (details will be described below). In the special mode, the awards are of the same type: receiving larger amounts of payouts than the normal mode. If there is an award linked to the combination of the five random numbers in the winning combination table, the first CPU 21 then decides to provide the award to the player. Note that the first ROM 22 stores two types of winning combination tables: the first type thereof is used in the normal mode, and the second type thereof is used in the special mode. Preferably, a first-type winning combination table is assigned to each payline.

The rules used in the special mode are broadly divided into two types: the first-type rule specifies the duration of the special mode, preferably, the maximum number of rounds of a bonus game conducted in the special mode. The second-type rule specifies the types of awards (preferably, the amount of payout) assigned to winning combinations by the winning judgment unit in the special mode. More preferably, the second-type rule specifies a payout ratio of the special mode to the normal mode. More specifically, a payout won as an award in the normal mode multiplied by the payout ratio equals a payout won as the same award in the special mode. For example, the slot machine uses three first-type rules that limit the maximum number of rounds of a bonus game to 10, 20, and 30, respectively, and three second-type rules that set a payout ratio at 1, 2, and 3, respectively. The first- and second-type rules are represented by distinctive pieces of rule data, which are preferably stored in the first RAM 23. Note that both the first- and second-type rules may vary with the types of bonus games and the designs of the slot games.

After the lottery process, the first CPU 21 controls the display control unit 25 in order to change from the spinning video reels to the stopped video reels on the five symbol display areas 11a of the monitor 11 (Step S7). Thus, the symbols linked to the random numbers in the stop position tables are arranged on the five symbol display areas 11a.

If an award in which a payout is received has been won under the lottery process (“Yes” in Steps S8 and S9), the first CPU 21 will control visual and sound effects by providing the lighting control unit 26 and the sound control unit 27 with commands after the stopped video reels has been displayed on the symbol display areas 11a. The lighting control unit 26 then turns on and off the lamps 10a, 10b and the lamp buttons equipped with internal light emitting devices, such as the buttons 6a, 6b, 7a, 7b, 7c, 8a, 8b, and 8c, in the patterns represented by the commands. The sound control unit 27 changes sounds reproduced from the speaker 15 to the sound effects represented by the commands. After that, the first CPU 21 performs a payout procedure (Step S10). More specifically, the first CPU 21 functions as a payout processing unit, i.e., it updates the credit data stored in the first RAM 23 to increase the credits by the payout to be provided as an award.

If an award that changes the rules has been won under the lottery process (“Yes” in Step S8, “No” in Step S9, and “Yes” in Step S11), the first CPU 21 will function as a rule managing unit, i.e., it will update the rule data stored in the first RAM 23 in accordance with the changing pattern assigned to the award. In this embodiment, in particular, the first CPU 21 will also function as a rule check unit, i.e., it will check whether or not a predetermined condition is satisfied between the original rule data stored in the first RAM 23 and new rule data updated in accordance with the award (Step S12). The predetermined condition is preferably a condition in which the new rule data is different from the original rule data. The first- and second-type rules are separately compared between the original and new rule data in accordance with the changing pattern assigned to the award, i.e., the first- and second-type rules are compared when the award is assigned to the change of the first- and second-type rules, respectively. When the first CPU 21 has determined that the predetermined condition is satisfied, i.e., the new rule data is different from the original rule data, the first CPU 21 functions as the rule managing unit to replace the original rule data with the new rule data (Step S13). Furthermore, the first CPU 21 controls the display control unit 25, and thereby displays the updated number of rounds and payout ratio on the round display area 11d and the odds display area 11e, respectively. When the first CPU 21 has determined that the predetermined condition is not satisfied, i.e., the new rule data is equivalent to the original rule data, the first CPU 21 will finish the slot game without changing the rules. Here, rule data initially stored in the first RAM 23 preferably indicates 10 rounds of a bonus game and a payout ratio of 1 as the first- and second-type rules, respectively.

If an award that changes the mode has been won under the lottery process (“Yes” in Step S8, “No” in Step S9, and “No” in Step S11), the first CPU 21 will first controls visual and sound effects as described above. Next, the first CPU 21 will change from the normal mode to the special mode. The first CPU 21 then reads the rule data from the first RAM 23 (Step S14), and sets the maximum number of rounds and the payout ratio of a bonus game at the values indicated by the rule data.

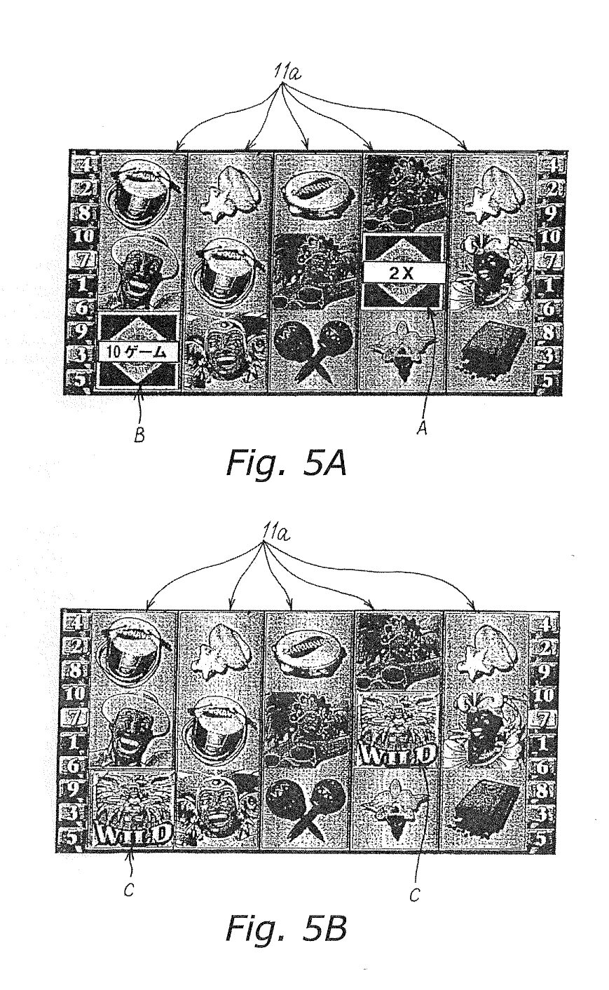

After that, the first CPU 21 conducts a bonus game under the rules (Step S15). The bonus game proceeds in substantially the same steps as the normal slot game. However, the bonus game is preferably a free game that a player can play without credits, in contrast to the normal slot game. In addition, the bonus game uses video reels on which symbols A and B that represent an award that change the rules (cf. FIG. 5A) are replaced with wildcard symbols C (cf. FIG. 5B). Here, the wildcard symbol C is a special symbol that is interpreted as any type of other symbols by the winning judgment unit (i.e., the first CPU 21). Accordingly, there is no chance of changing the rules in the bonus game, in contrast to the normal slot game, but there are greater chances of winning other types of awards in the bonus game than in the normal slot game. Note that numbers, types, or arrangements of symbols on the video reels may be completely changed between the normal and special modes.

If an award of receiving a payout has been won in the bonus game, the first CPU 21 will first control specific visual and sound effects by providing the lighting control unit 26 and the sound control unit 27 with commands. Next, the first CPU 21, or the payout processing unit, will update the credit data stored in the first RAM 23 to increase the credits by the payout. Here, the payout equals a payout won as the same award in the normal mode multiplied by a payout ratio, which is set in accordance with the second-type rule at the change from the normal mode to the special mode (Step S14). For example, when the payout ratio is set at 1, 2, or 3, a payout won as an award in the special mode is 1, 2, or 3 times as large as a payout won as the same award in the normal mode.

When the number of rounds of the bonus game reaches the maximum set in accordance with the first-type rule at the change from the normal mode to the special mode (Step S14), the first CPU 21 will change from the special mode to the normal mode, and in particular reset the rule data stored in the first RAM 23 (Step S16). For example, the rule data is updated to indicate 10 rounds of a bonus game and a payout ratio of 1 as the first- and second-type rules, respectively.

As described above, the first RAM 23 stores rule data that indicates two types of rules; the maximum number of rounds and the payout ratio of a bonus game. The slot machine 1 conducts a bonus game under the two types of rules in the special mode. The rules are changed if a player wins an award that changes the rules in a slot game conducted in the normal mode. The rules can become advantageous or disadvantageous to the player. Here, the current rules are easy to know from the displays on the bonus round display area 11d and the odds display area 11e on the monitor 11. When the player satisfies the current rules, the player wants to win an award that changes the mode, not an award that changes the rules, and vice versa. This can enhance the player's willingness to play a slot game in the normal mode, i.e., it can make the normal mode more attractive.

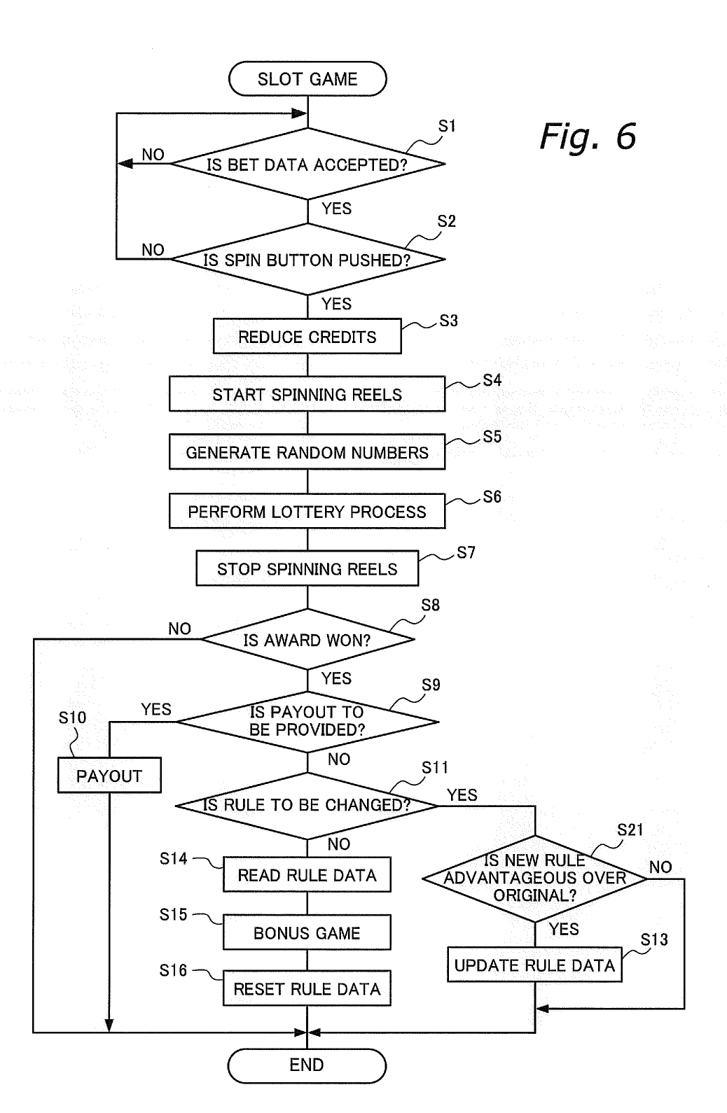

The slot machine according to the above embodiment may be modified to various forms. In a modification, a slot game proceeds in the steps shown in FIG. 6. In particular, the condition used in Step S12 is replaced with a stronger condition in which the new rule data is advantageous to a player over the original rule data. Note that other configurations and functions are similar to those of the slot machine of the above embodiment, and accordingly the description thereof can be found above in the description about the embodiment.

If an award that changes the rules has been won under the lottery process at Step S6 (“Yes” in Step S8, “No” in Step S9, and “Yes” in Step S11), the first CPU 21 will function as a rule managing unit, i.e., it will update the rule data stored in the first RAM 23 in accordance with the changing pattern assigned to the award. In this modification, in particular, the first CPU 21 will also function as a rule check unit, i.e., it will check whether or not the new rule data updated in accordance with the award is advantageous to a player over the original rule data stored in the first RAM 23 (Step S21). The first- and second-type rules, e.g., the maximum number of rounds and the payout ratios, are separately compared between the original and new rule data when the award is assigned to the change of the first- and second-type rules, respectively. When the first CPU 21 has determined that the predetermined condition is satisfied, i.e., the new rule data is advantageous over the original rule data, the first CPU 21 functions as the rule managing unit to replace the original rule data with the new rule data (Step S13). Furthermore, the first CPU 21 controls the display control unit 25, and thereby displays the updated round number and payout ratio on the round display area 11d and the odds display area 11e, respectively. When the first CPU 21 has determined that the predetermined condition is not satisfied, i.e., the new rule data is not advantageous over the original rule data, the first CPU 21 will finish the slot game without changing rules.

As described above, even if an award that changes the rules is won, the modified slot machine maintains the original rule data in the first RAM 23 unless new rule data is advantageous to a player over the original rule data. This allows a player who wins the award that changes the rules in a normal slot game to play a bonus game under a more advantageous rule. This may make the normal mode further more attractive, since there is little doubt that the winning of an award that changes the rules always enhances the player's willingness to play a bonus game.

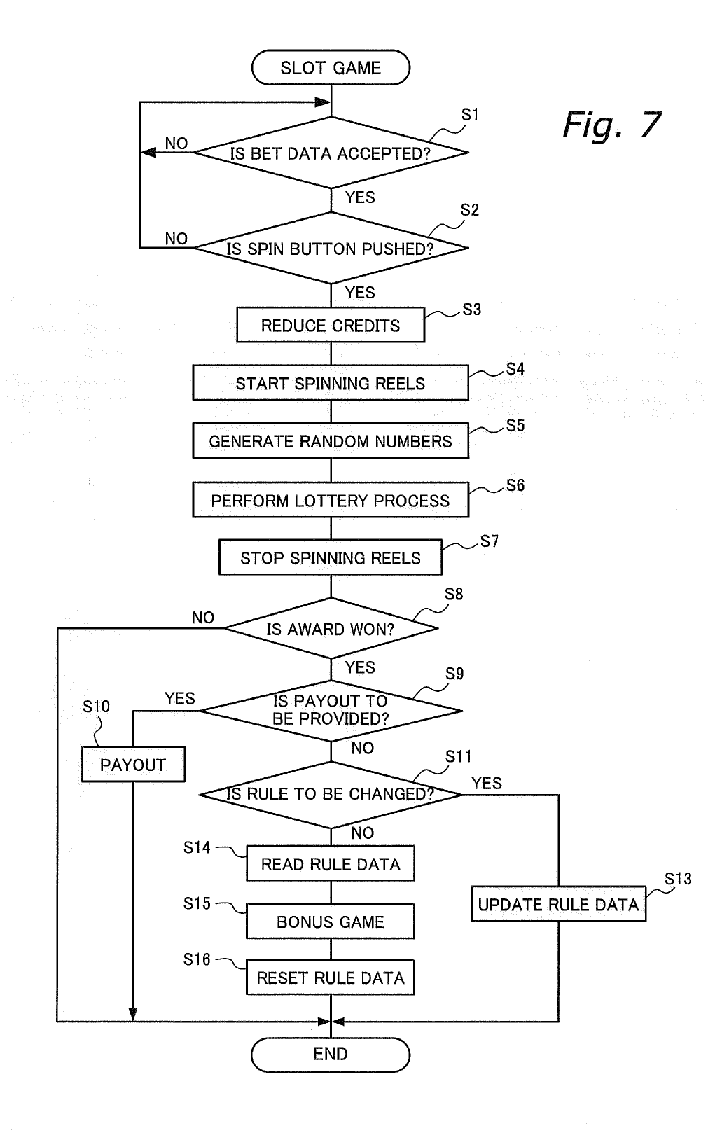

In another modification, a slot game proceeds in steps shown in FIG. 7. In particular, the first CPU 21, or a rule managing unit, updates rule data stored in the first RAM 23, whenever an award that changes the rules is won in the normal mode. Note that other configurations and functions are similar to those of the slot machine of the above embodiment, and accordingly the description thereof can be found above in the description of the embodiment.

If an award that changes the rules has been won under the lottery process at Step S6 (“Yes” in Step S8, “No” in Step S9, and “Yes” in Step S11), the first CPU 21 will function as a rule managing unit, i.e., it will update rule data stored in the first RAM 23 in accordance with the changing pattern assigned to the award. In this modification, in particular, regardless of the relationship between the original rule data and new rule data updated in accordance with the award, the original rule data is replaced with the new rule data (Step S13). Furthermore, the first CPU 21 controls the display control unit 25, and thereby displays the updated round number and payout ratio on the round display area 11d and the odds display area 11e, respectively.

As described above, whenever an award that changes the rules is won, the modified slot machine updates rule data stored in the first RAM 23, regardless of the relationship between the original and new rule data. This reduces the burdens of updating the rule data on the modified slot machine.

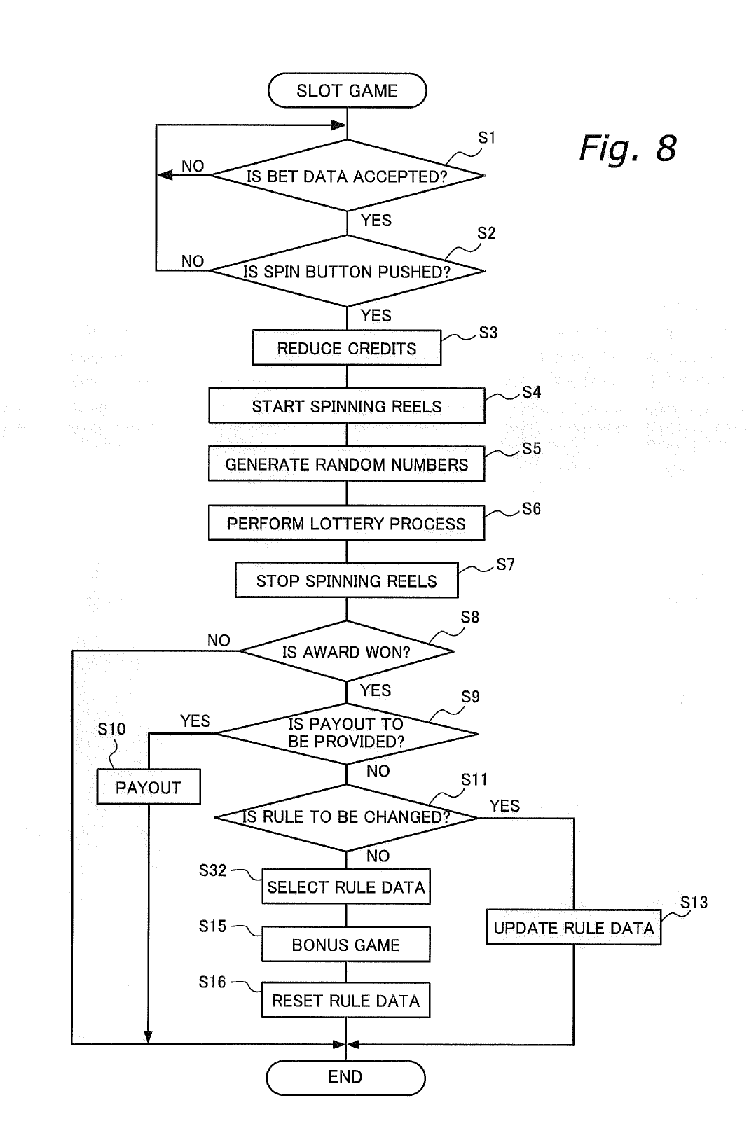

In yet another modification, a slot game proceeds in the steps shown in FIG. 8. In particular, the first CPU 21, or a rule managing unit, adds new rule data to the original rule data stored in the first RAM 23, whenever an award that changes the rules is won in the normal mode. In the special mode, one piece of the rule data is selected at random from the first RAM 23, and a bonus game is conducted under the selected rule. Note that other configurations and functions are similar to those of the slot machine of the above embodiment, and accordingly the description thereof can be found above in the description of the embodiment.

If an award that changes the rules has been won under the lottery process at Step S6 (“Yes” in Step S8, “No” in Step S9, and “Yes” in Step S11), the first CPU 21 will function as a rule managing unit, i.e., it will add new rule data, which is assigned to the award, to the original rule data stored in the first RAM 23 (Step S31). Here, the number of rounds and the payout ratio of a bonus game do not have to be displayed on the round display area 11d and the odds display area 11e, respectively. Preferably, lists of the number of rounds and the payout ratios included in the current rule data are displayed on the monitor 11 or other screen installed on the slot machine.

If an award that changes the mode has been won under the lottery process at Step S6 (“Yes” in Step S8, “No” in Step S9, and “No” in Step S11), the first CPU 21 will first control the visual and sound effects as described above. Next, the first CPU 21 will change from the normal mode to the special mode. At that time, the first CPU 21 will also function as a rule selecting unit, i.e., it will select one piece of the rule data stored in the first RAM 23, preferably by using a lottery process similar to that at Steps S5 and S6 (Step S32). Here, the first- and second-type rules are separately selected. Note that if the first RAM 23 stores only one piece of rule data, the above selection process may be skipped. The first CPU 21 then sets the maximum number of rounds and the payout ratio of a bonus game at the values indicated by the selected rule data.

During the normal mode, winning an award that changes the rules each time increases the variety of the rules selectable by the first CPU 21, or the rule selecting unit. This may makes the normal mode even more attractive, since a player who wins the award that changes the rules a larger number of times in the normal mode has greater chances of playing a game in the special mode under a more advantageous rule.

In contrast to the above embodiment and its modifications, the rule data stored in the first RAM 23 may indicate an increment or a decrement to be added to a default value of the maximum number of rounds or the payout ratio of a bonus game. This reduces the space in the first RAM 23 allocated to the storage space for rule data.

### General Interpretation of Terms

In understanding the scope of the present invention, the term “configured” as used herein to describe a component, section or portion of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single portion or a plurality of portions. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A slot machine configured to selectively provide a game in a normal mode and a special mode, comprising:
a reel unit configured to display a plurality of reels, each of the reels comprising a series of symbols arranged in a predetermined order;
a console unit configured to allow a player to enter bet data therein;
a bet processing unit configured to receive an amount of credits equal to an amount of a bet represented by the bet data when the console unit has accepted the bet data;
a start signal generator unit configured to generate a start signal after the bet processing unit has received the amount of credits;
a lottery unit configured to determine each symbol to be arranged on the reels in stopped positions by the reel unit in response to the start signal;
a reel control unit configured to cause the reel unit to start continuously changing symbols by rotation of the reels in response to the start signal, and after that, arrange the symbols that the lottery unit has determined on the reels in the stopped positions;
a winning judgment unit configured to
assign winning combinations of symbols to awards, the awards comprising an award that changes the game mode from the normal mode to the special mode, an award that changes the rules to be used in the special mode, and an award that allows a payout to be received while the game is conducted in the normal mode; and
check whether or not one of the winning combinations is included in the arrangement of the symbols that the lottery unit has determined;
a payout processing unit configured to provide a payout on the basis of the bet data and the winning combination that the winning judgment unit has found in the arrangement of the symbols;
a memory unit configured to store rule data used in the special mode;
a rule managing unit configured to update the rule data stored in the memory unit in accordance with the winning combination that the winning judgment unit has found in the arrangement of the symbols; and
a controller unit configured to selectively conduct a game in the normal and special modes, change from the normal mode to the special mode in accordance with the winning combination that the winning judgment unit has found in the arrangement of the symbols, and use the rule data stored in the memory unit in the special mode.

2. The slot machine according to claim 1, further comprising
a rule check unit configured to check whether or not a predetermined condition is satisfied between the original rule data stored in the memory unit and new rule data updated in accordance with the winning combination that the winning judgment unit has found in the arrangement of the symbols; and
wherein the rule managing unit is configured to replace the original rule data with the new rule data, when the rule check unit has judged that the predetermined condition is satisfied.

3. The slot machine according to claim 2, wherein the predetermined condition is a condition in which the new rule data is different from the original rule data.

4. The slot machine according to claim 2, wherein the predetermined condition is a condition in which the new rule data is advantageous to a player over the original rule data.

5. The slot machine according to claim 1, wherein the rule managing unit is configured to update the rule data stored in the memory unit, whenever the winning judgment unit has found the winning combination assigned to the award which changes the rules to be used in the special mode.

6. The slot machine according to claim 1, further comprising
a rule selecting unit configured to select one of the rule data stored in the memory unit by using a lottery process; and
wherein the rule managing unit is configured to add new rule data to the rule data stored in the memory unit in accordance with the winning combination that the winning judgment unit has found in the arrangement of the symbols; and
the controller unit is configured to use the rule data selected by the rule selecting unit in the special mode.

7. The slot machine according to claim 1, wherein the rule data indicates the duration of the special mode.

8. The slot machine according to claim 1, wherein the rule data indicates the types of awards assigned to winning combinations by the winning judgment unit in the special mode.

9. The slot machine according to claim 1, wherein the rule data indicates the amounts of payouts assigned to winning combinations by the winning judgment unit in the special mode.
